(19) United States
(12) Patent Application Publication
(10) Pub. No.: US 2008/0316580 A1
(43) Pub. Date: Dec. 25, 2008

(54) Fibre, Flexible Display Device Manufactured Thereform and Corresponding Manufacturing Methods

(75) Inventors: Murray Gillies, Eindhoven (NL); Lucas J.M. Schlangen, 'S-Hertogenbosch (NL); Edzer Huitema, Veldhoven (NL); Martijn Krans, Den Bosch (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/574,739

(22) PCT Filed: Sep. 9, 2005
(86) PCT No.: PCT/IB05/52953

§ 371 Date: Mar. 6, 2007

(30) Foreign Application Priority Data
Sep. 11, 2004 (GB) 0420225.5

(51) Int. Cl. G02F 1/167; B29D 11/00

(52) U.S. Cl. 359/296; 264/1.7

(57) ABSTRACT

A fibre (10) comprises an inner conductor (12), a volume (14) of electro-optic material (16), an external conductor (20), with a photoconductor (18) between the inner conductor and an external conductor. The volume of electro-optic material comprises capsules of electrophoretic, black and white charged particles (24, 26), the black particles having an opposite charge to the white particles. The components of the fibre are flexible, such that the fibre is suitable for use in a flexible display device.

This invention relates to a fibre for use in a flexible display device, to a method of manufacturing such a fibre, to a flexible display device, and to a method of manufacturing the display device.

A wide variety of different display devices are known. Flexible displays are currently attracting significant attention. These displays are often flexible in so far as they are constructed on a flexible substrate and can be curved in one direction. For many applications this is sufficient but in the new area of wearable electronics, where displays on clothing is considered an interesting topic, the demands are higher. When considering technology that is appropriate for wearable displays then the following demands are relevant; it is important that the display is flexible in all directions, that it appears as fabric, that it is cheap to manufacture and finally that it is easily addressable, meaning that the integrated electronics and or connections, in the clothing, required to display the image, are minimal.

U.S. Pat. No. 6,542,284 discloses a display device and a manufacturing method. The display device disclosed in this patent is for use in a microcapsule type electrophoretic display apparatus and a manufacturing method therefore is described, in which microcapsules can be aligned so as to form a monolayer. A display device is provided in which a colour display can be created, with improved contrast, and a manufacturing method therefore is also provided. The display device includes a substrate, an insulating liquid, charged colour particles dispersed therein, a first electrode formed on the substrate, and a second electrode, wherein a display is created by causing the migration of the charged colour particles toward the first electrode or the second electrode by a voltage applied therebetween. The microcapsules are each formed by enclosing the insulating liquid and the charged colour particles in a transparent container, and the microcapsules are aligned and are enclosed in fibres composed of a light transmissive resin.

However, this display device is at best flexible in one dimension only, and requires extensive electronics to control the output of each specific pixel, as each pixel must be addressed individually. The manufacture of the display is also overly complicated, as each pixel is comprised of an individual transparent container.

International patent application publication WO2004/055576 discloses an electro-optic filament or fibre. The electro-optic filament or fibre includes an elongate core extending lengthwise within a volume of polarisable material, with an outer electrode member overlying the volume. The core and outermember are electrically conducting and connectable to electrical potentials to generate a radial field in the polarisable material. The outer member is optically transmissive and/or transflective. The polarisable material exhibits an optical effect such as a colour change, change in polarisation or change in reflectivity, when subjected to a said field or a change in a said field. The filament or fibre may readily be woven into a fabric or a garment, using conventional textile processing machinery.

While the fibre of this patent application is suitable for use in flexible display devices, the device that can be created is limited in so far as either each fibre must have a single colour or complicated electronics must be used at the junctions of fibres to create a pixellated display.

It is therefore an object of the invention to improve upon the known art.

According to a first aspect of the present invention, there is provided a fibre comprising an inner conductor, a volume of electro-optic material, an external conductor, and a photoconductor between the inner conductor and the external conductor.

According to a second aspect of the present invention, there is provided a display device comprising a plurality of fibres, each fibre comprising an inner conductor, a volume of electro-optic material, an external conductor, and a photoconductor between the inner conductor and the external conductor, and a source of electrical potential connected to the conductors of the fibres.

According to a third aspect of the present invention, there is provided a method of manufacturing a fibre comprising receiving an inner conductor and an external conductor, coating either the inner conductor or the external conductor with a photoconductor, and filling the volume between the inner conductor and the external conductor with electro-optic material.

According to a fourth aspect of the present invention, there is provided a method of manufacturing a fibre comprising receiving an inner conductor, and successively coating the inner conductor with a photoconductor, an electro-optic material and an external conductor.

According to a fifth aspect of the present invention, there is provided a method of manufacturing a display device comprising receiving a plurality of fibres, each fibre comprising an inner conductor, a volume of electro-optic material, an external conductor, and a photoconductor between the inner conductor and the external conductor, weaving the fibres into a fabric, and connecting a source of electrical potential to the conductors of the fibres.

Owing to the invention, it is possible to provide a display device that is flexible in two dimensions, that is simple to construct, and does not have a large number of electrical connections, but can provide an effectively pixellated display. When the photoconductor in each fibre is exposed to light, a potential difference is created over the volume of electro-optic material. The electro-optic material will change appearance according to its properties, and this structure of fibre can be harnessed to create a flexible display.

Advantageously, the photoconductor is in-between the inner conductor and the volume of electro-optic material or it is in-between the volume of electro-optic material and the external conductor. Typically it will be coated on to the inner conductor, but the position of the photoconductor in the fibre is a design choice.

Preferably, the volume of electro-optic material comprises capsules of electrophoretic particles, the electrophoretic particles being black and white charged particles, the black particles having an opposite charge to the white particles. Advantageously, the inner conductor and the external conductor are connectable to a source of electrical potential. As mentioned above, when the photoconductor in any part of a fibre is exposed to light, a potential difference is created over the electrophoretic particles, for example, bringing the charged black particles to the exterior of the fibre. Since, ideally, the external conductor is substantially optically transparent, the black electrophoretic particles will be visible in the fibres. Therefore at all points where light is directed onto the display device, the black electrophoretic particles will be brought to the surface of the fibres, creating an image.

Advantageously, the components of the fibre are flexible, such that the fibre is suitable for use in a flexible display device, and the fibre is of substantially circular cross-section, with the inner conductor, the photoconductor, the volume of electro-optic material and the external conductor being substantially concentric.

Preferably, the inner conductor comprises a flexible rod comprising one or more of a metal, a conducting polymer, and a polyamide coated with a conducting material.

Embodiments of the present invention will now be described, by way of example only, with reference to the accompanying drawings, in which:—

FIG. 1 is a cross-section through a fibre for use in a flexible display device,

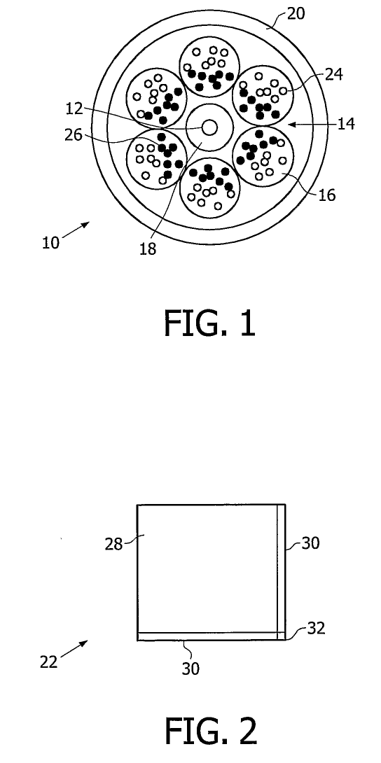

FIG. 2 is a schematic view of a flexible display device,

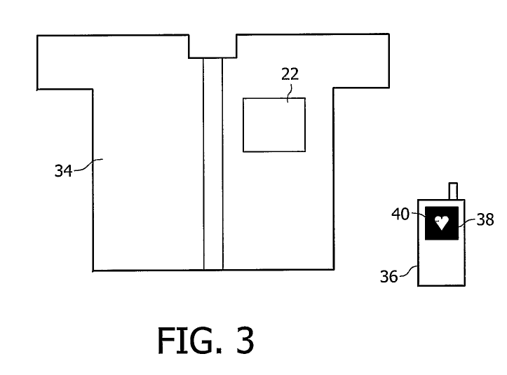

FIG. 3 is a schematic view of a mobile telephone and a garment incorporating the flexible display device,

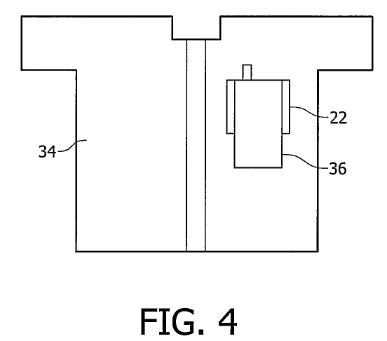

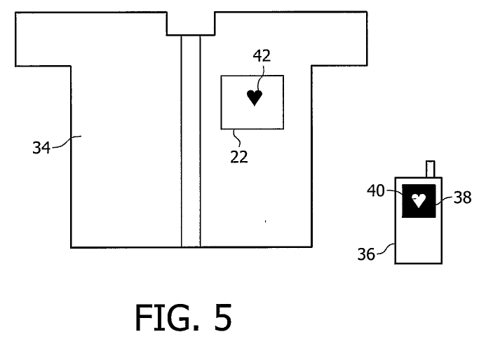

FIG. 4 is a schematic view, similar to FIG. 5, of the mobile telephone in contact with the flexible display device of the garment,

FIG. 5 is a schematic view, similar to FIG. 5, of the mobile telephone and the garment incorporating the flexible display device

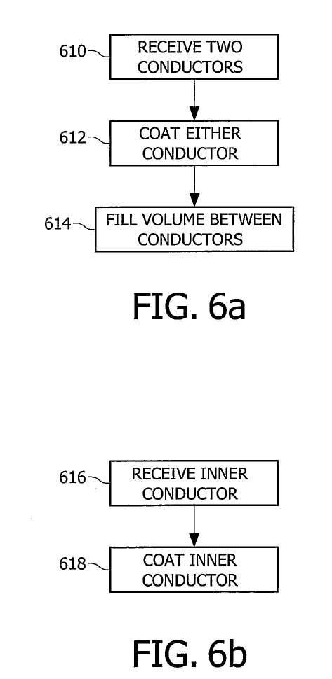

FIG. 6a is a flow diagram of a method of manufacturing a fibre,

FIG. 6b is a flow diagram of an alternative method of manufacturing a fibre, and

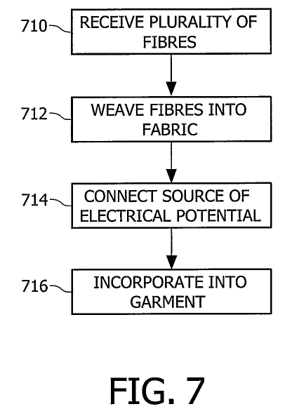

FIG. 7 is a flow diagram of a method of manufacturing a flexible display device.

The fibre 10 of FIG. 1 comprises an inner conductor 12, a volume 14 of electro-optic material 16, an external conductor (20), with a photoconductor 18 between the inner conductor 12 and the external conductor 20. The fibre 10 is of uniform construction along its length, and the fibre 10 is substantially circular in cross-section, with the inner conductor 12, the photoconductor 18, the volume 14 of electro-optic material 16 and the external conductor 20 being substantially concentric. The inner conductor 12 and the external conductor 20 are connectable to a source of electrical potential.

Each of the individual components of the fibre 10 are flexible, such that the fibre 10 is suitable for use in a flexible display device 22, shown schematically in FIG. 2. The fibres 10 are suitable for being woven into the display device 22, in the same manner that a patch of fabric would be made.

The photoconductor 18, when it is not exposed to light, acts as an insulator around the inner conductor 12. When light is directed at any part of the photoconductor 18, its electrical properties will change, and its resistance will fall, so that rather than being an insulator, it acts as a conductor. This results in an electrical field being created across the volume 14, which contains the electro-optic material 16.

A material that is electro-optic is one whose optical characteristics change dependent upon the electrical condition it is in. In the preferred embodiment of the fibre 10, shown in FIG. 1, the volume 14 of electro-optic material 16 comprises capsules 16 of electrophoretic particles 24 and 26. The electrophoretic particles 24 and 26 are black and white charged particles, the black particles 26 having an opposite charge to the white particles 24.

The charged particles 24 and 26 in the capsules 16 will flow in the capsules 16, when an electrical field is acting on them. As discussed above, when light is directed onto the photoconductor 18, an electrical field will be present across the volume 14, which contains the capsules 16. In FIG. 1, the black particles 26 are positioned such that they are towards the centre of the fibre 10.

The capsules 16 (or the volume 14 between the capsules 16) allow transmission of some light in order to illuminate the photoconductor 18. If the addressing light is monochrome, then ideally the capsules 16 will transmit this wavelength, but be opaque for other wavelengths. This will also assist in preventing interference in the working of the display device by ambient light.

If it is assumed that the black particles have a negative charge, and the external conductor 20 is at a positive electrical potential, then when the photoconductor 18 conducts rather than insulates, the field that is created will act on the black particles 26 to attract them towards the external conductor 20. At the same time, the white particles 24, being positively charged, will be attracted to the negative pole, being the inner conductor 12. Since the external conductor 20 is substantially optically transparent, the appearance of the fibre 10 will change, since the black particles 26 will now be visible. When the light source is no longer directed on the photoconductor 18, it will return to insulating the inner conductor, and there will no longer be a field present across the volume 14. When there is no field present, the electrophoretic particles 24 and 26 do not move. This allows the optical characteristics of the fibre to be changed in a simple and efficient manner, without the need for any continuous electrical potential to maintain the change in the appearance of the display device 22.

The display device 22 also has only a minimum of connections, shown schematically in FIG. 2. The weave of fibres 28 are connected via connectors 30 to the source of electrical potential 32. All of the inner conductors 12 in the row and column fibres are connected to a DC voltage of, for example, 30 volts, and all of the external conductors 20 are connected to the 0 volt side of the source of electrical potential 32.

Typically, the inner conductor 12 in each fibre 10 comprises a flexible rod comprising one or more of a metal, a conducting polymer, and a polyamide coated with a conducting material. In a simplest embodiment, the inner conductor 12 is a copper wire with a 4 um thick layer of organic photoconductor 18 provided thereon.

FIGS. 3 to 5 show an example of the flexible display device 22, which has been incorporated into a garment 34. The display device 22 can be sown onto the garment 22, in much the same way as a pocket is provided on the front of a shirt.

In FIG. 3, the flexible display device 22 is in a condition such that all of the fibres 10 making up the device 22 have the white electrophoretic particles 24 towards the outside of each fibre 10, resulting in the all white display shown in FIG. 3. The wearer of the garment 34 also has a mobile telephone 36, with a typical emissive display 38. The display 38 of the phone 36 is currently showing a heart shaped icon 40. For reasons of clarity, the remainder of the display 38 is shown in black, although it should be appreciated, that in a working display 38, the heart icon 40 would be emitting light, and the remainder of the display 38 would not be emitting any light.

If the user wishes to produce an image on the display device 22, then they can, for example, hold the mobile phone 36 up to the display device 22, as shown in FIG. 4. As described above, with reference to a single fibre 10, the light emitted by the phone 36 will cause the photoconductor coatings 18 of the inner conductors 12 of the individual fibres 10 to become conductive, thereby creating an electric field across the electrophoretic particles. This creates localised changes in the display 22, as the electrophoretic particles move in the electric field.

Once the user removes the mobile phone 36 from the display device 22, then the garment 34 will look as shown in FIG. 5. The flexible display device 22 is now displaying the image 42 of the heart icon, which corresponds to the heart icon 40 on the display 38 of the mobile phone 36. While displaying the icon 42 on the display device 22, no power is being used, as the image is created by the black particles in the electrophoretic material.

In an alternative embodiment of the display device, the mobile phone 36 could also be used to provide the power for the display device 22. The mobile phone 36 could be coupled to the display device 22 by two simple point contacts, or via capacitive or inductive means. This even further simplifies the construction of the display device 22 and of the garment 34.

If the user wishes to change the display of the image on the display device 22, then it is necessary for them to switch the polarity of the source of electrical potential in the display device 22, which can be provided by a simple press switch (not shown) on the device 22. Once the polarity has been switched, then the user must bring a light source, such as the mobile phone 36 to those parts of the display 22 that are currently showing an image. This will once again cause the photoconductor coatings 18 of the inner conductors 12 of the individual fibres 10 to become conductive, thereby creating an electric field across the electrophoretic particles, but with an opposite polarity than that used when creating an image. This causes the white electrophoretic particles to move in the electric field, to create a uniformly white display on the device 22. It does not matter if the user shines light on those parts of the display that are already white, as the electric field created in those parts of the display device will have no effect on the white electrophoretic particles, as they are already at the surface of the individual fibres of the display 22.

An alternative method of resetting the display device is possible. This is achieved by repeatedly applying a square block voltage rather than the DC voltage used when writing to the display. Due to the capacitive imbalance between the 4 um thick photoconductor and the 40 um electrophoretic capsules, the image can be reset in this way.

In this way, a user can transfer images to a flexible display for use in applications such as garments or furnishings, without needing power to maintain the image on the display 22. A small amount of power is used for a short period of time, no longer than one second, when an image is transferred to display 22.

FIG. 6a shows a flowchart summarising a method of manufacturing the fibre 10. The method comprises receiving 610 the inner conductor 12 and the external conductor 20, coating 612 either the inner conductor 12 or the external conductor 20 with the photoconductor 18, and filling 616 the volume 14 between the inner conductor 12 and the external conductor 20 with electro-optic material 16.

FIG. 6b shows a flowchart of an alternative method of manufacturing the fibre 10. This method comprises receiving 616 the inner conductor 12, and successively coating 618 the inner conductor 12 with the photoconductor 18, the electro-optic material 16 and the external conductor 20.

Likewise, FIG. 7 shows a flowchart that summarises the method of manufacturing the display device 22, which comprises receiving 710 a plurality of fibres 10, each fibre 10 comprising the inner conductor 12, the volume 14 of electro-optic material 16, the external conductor and the photoconductor 18 between the inner conductor 12 and the external conductor 20. The second stage in the method is to weave 712 the fibres 10 into a fabric, followed by connecting 714 a source of electrical potential to the conductors of the fibres 10. The final stage 716 is to incorporate the final display into the garment 34.

It is therefore possible to create a light sensitive electrophoretic fibre that can be woven into fabric. While the material is not addressed, it will appear as fabric, but when required, the grey level can be modulated along the length of the fibre, such that it can be used to display an image. In contrast to known techniques, the fibre is self-contained and does not rely on good electrical contact with other fibres, only requiring two electrical connections for the whole display area and the resulting display is not sensitive to short-circuiting between the internal and external conductors.

A separate device is required that can supply spatially modulated light, for example, a polyLED passive matrix display. This addresses all areas of the display in parallel and so the addressing time is at most 0.5 of a second.

A possible coating of the inner conducting fibres is a 4 um thick layer of organic photoconductor. The material could be, for example, poly(9 [symbol] vinylcarbazole), PVK, with a photosensitive dopant, for example, trinitrofluorenone. This can be achieved simply, by drawing a copper wire through a solution of the photoconductor. The fibres are then enclosed within a hollow external conducting fibre. These fibres can now be used to make a garment where images can be displayed but in all other aspects has the feel of normal clothing.

A fabric woven from the fibres can be optically addressed by simply connecting all inner conducting elements to a DC voltage of for example 30V and grounding the external electrode. Since the photoconductor is an insulator, when not exposed to light, the voltage is dropped over this layer. There is no voltage drop over the electrophoretic capsules. Upon illuminating a section of the fibre, the photoconductor resistance decreases and the voltage division is changed so that there is a large drop across the capsules. This causes them to locally switch.

There are various methods for transferring an image to the display device. These include; exposing the fabric to light through a shadow mask (i.e. a printed overhead sheet), holding the fabric against a display or writing on the fabric with a laser pen or a scanning laser. It is imaginable that people could download new logos onto their mobile phones and copy them to the display simply by holding it against their clothing.

Other options exist for addressing larger areas with a handheld device. The display can also be reset or erased with a voltage pulse and after it has been written it requires no sustaining power. The display is only light sensitive when a voltage is applied, and there are therefore no issues of it fading in external sunlight after it has been addressed.

While it is illustrated in the preferred embodiment, that the electro-optic material could be made up of electrophoretic capsules, other materials are possible. For example, instead of using capsules it is possible to use dyed oil in which white electrophoretic particles are present. By attracting the white particles to the inner electrode the fibre displays the colour of the oil but when attracted to the outer electrode it is white. Alternatively other materials displaying electro-optical effects could be placed in the cavity for example, PDLC (polymer dispersed liquid crystal), and types of gel. The electro-optic material could also comprise liquid crystal with a polarizer encircling the liquid crystal.

1. A fibre comprising an inner conductor (12), a volume (14) of electro-optic material (16), an external conductor (20), and a photoconductor (18) between the inner conductor (12) and the external conductor (20).

2. A fibre according to claim 1, wherein the photoconductor (18) is in-between the inner conductor (12) and the volume (14) of electro-optic material (16).

3. A fibre according to claim 1, wherein the photoconductor (18) is in-between the volume (14) of electro-optic material (16) and the external conductor (20).

4. A fibre according to claim 1, wherein the volume (14) of electro-optic material (16) comprises electrophoretic particles (24, 26).

5. A fibre according to claim 4, wherein the electrophoretic particles (24, 26) are contained within capsules (16).

6. A fibre according to claim 4, wherein the electrophoretic particles (24, 26) have different charge and optical properties.

7. A fibre according to claim 6, wherein the electrophoretic particles (24, 26) are black and white charged particles (24, 26), the black particles (26) having an opposite charge to the white particles (24).

8. A fibre according to claim 1, wherein the external conductor (20) is substantially optically transparent.

9. A fibre according to claim 1, wherein the components of the fibre (10) are flexible, such that the fibre (10) is suitable for use in a flexible display device (22).

10. A fibre according to claim 1, wherein the inner conductor (12) comprises a flexible rod comprising one or more of a metal, a conducting polymer, and a polyamide coated with a conducting material.

11. A fibre according to claim 1, wherein the fibre (10) is of substantially circular cross-section, with the inner conductor (12), the photoconductor (18), the volume (14) of electro-optic material (16) and the external conductor (20) being substantially concentric.

12. A fibre according to claim 1, wherein the inner conductor (12) and the external conductor (20) are connectable to a source of electrical potential.

13. A display device comprising a plurality (28) of fibres (10), each fibre (10) comprising an inner conductor (12), a volume (14) of electro-optic material (16), an external conductor (20), and a photoconductor (18) between the inner conductor (12) and the external conductor (20), and a source of electrical potential (32) connected to the conductors (12, 20) of the fibres (10).

14. A display device according to claim 13, wherein the photoconductor (18) in each fibre (10) is in-between the inner conductor (12) and the volume (14) of electro-optic material (16).

15. A display device according to claim 13, wherein the photoconductor (18) in each fibre (10) is in-between the volume (14) of electro-optic material (16) and the external conductor (20).

16. A display device according to claim 13, wherein the volume (14) of electro-optic material (16) in each fibre (10) comprises electrophoretic particles (24, 26).

17. A display device according to claim 16, wherein the electrophoretic particles (24, 26) in each fibre (10) are contained within capsules (16).

18. A display device according to claim 16, wherein the electrophoretic particles (24, 26) in each fibre (10) have different charge and optical properties.

19. A display device according to claim 18, wherein the electrophoretic particles (24, 26) in each fibre (10) are black and white charged particles (24, 26), the black particles (26) having an opposite charge to the white particles (24).

20. A display device according to claim 13, wherein the external conductor (20) of each fibre (10) is substantially optically transparent.

21. A display device according to claim 13, wherein the components of the each fibre (10) of the display device (22) are flexible, such that the display device (22) is a flexible display device (22).

22. A display device according to claim 13, wherein the inner conductor (12) of each fibre (10) comprises a flexible rod comprising one or more of a metal, a conducting polymer, and a polyamide coated with a conducting material.

23. A display device according to claim 13, wherein each fibre (10) is of substantially circular cross-section, with the inner conductor (12) the photoconductor (18), the volume (14) of electro-optic material (16) and the external conductor (20) being substantially concentric.

24. A method of manufacturing a fibre (10) comprising receiving (610) an inner conductor (12) and an external conductor (20), coating (612) either the inner conductor (12) or the external conductor (20) with a photoconductor (18), and filling (614) the volume (14) between the inner conductor (12) and the external conductor (20) with electro-optic material (16).

25. A method of manufacturing a fibre (10) comprising receiving (616) an inner conductor (12), and successively coating (618) the inner conductor (12) with a photoconductor (18), an electro-optic material (16) and an external conductor (20).

26. A method according to claim 24, wherein the electro-optic material (16) comprises electrophoretic particles (24, 26).

27. A method according to claim 26, wherein the electro-optic material (16) comprises capsules (16) of electrophoretic particles (24, 26).

28. A method according to claim 26, wherein the electrophoretic particles (24, 26) have different charge and optical properties.

29. A method according to claim 28, wherein the electrophoretic particles (24, 26) are black and white charged particles (24, 26), the black particles (26) having an opposite charge to the white particles (24).

30. A method according to claim 24, wherein the external conductor (20) is substantially optically transparent.

31. A method according to claim 24, wherein the components of the fibre (10) are flexible, such that the fibre (10) is suitable for use in a flexible display device (22).

32. A method according to claim 24, wherein the inner conductor (12) comprises a flexible rod comprising one or more of a metal, a conducting polymer, and a polyamide coated with a conducting material.

33. A method according to claim 24, wherein the fibre (10) is of substantially circular cross-section, with the inner conductor (12), the photoconductor (18), the volume (14) of electro-optic material (16) and the external conductor (20) being substantially concentric.

34. A method according to claim 24, wherein the inner conductor (12) and the external conductor (20) are connectable to a source of electrical potential.

35. A method of manufacturing a display device comprising receiving (710) a plurality of fibres (10), each fibre (10) comprising an inner conductor (12), a volume (14) of electro-optic material (16), an external conductor (20), and a photoconductor (18) between the inner conductor (12) and the external conductor (20), weaving (712) the fibres (10) into a fabric (28), and connecting (714) a source of electrical potential (32) to the conductors (12, 20) of the fibres (10).

36. A method according to claim 35, wherein the photoconductor (18) in each fibre (10) is in-between the inner conductor (12) and the volume (14) of electro-optic material (16).

37. A method according to claim 35, wherein the photoconductor (18) in each fibre (10) is in-between the volume (14) of electro-optic material (16) and the external conductor (20).

38. A method according to claim 35, wherein the volume (14) of electro-optic material (16) in each fibre (10) comprises electrophoretic particles (24, 26).

39. A method according to claim 38, wherein the electrophoretic particles (24,26) in each fibre (10) are contained within capsules (16).

40. A method according to claim 38, wherein the electrophoretic particles (24, 26) in each fibre (10) have different charge and optical properties.

41. A method according to claim 40, wherein the electrophoretic particles (24, 26) in each fibre (10) are black and white charged particles (24, 26), the black particles (26) having an opposite charge to the white particles (24).

42. A method according to claim 35, wherein the external conductor (20) of each fibre (10) is substantially optically transparent.

43. A method according to claim 35, wherein the components of the each fibre (10) of the display device (22) are flexible, such that the display device (22) is a flexible display device (22).

44. A method according to claim 35, wherein the inner conductor (12) of each fibre (10) comprises a flexible rod comprising one or more of a metal, a conducting polymer, and a polyamide coated with a conducting material.

45. A method according to claim 35, wherein each fibre (10) is of substantially circular cross-section, with the inner conductor (12), the photoconductor (18), the volume (14) of electro-optic material (16) and the external conductor (20) being substantially concentric.
